(19) United States
(12) Patent Application Publication
(10) Pub. No.: US 2026/0359618 A1
(43) Pub. Date: Nov. 12, 2026

(54) QUANTIZATION ENHANCING TRANSFORMATIONS FOR DIFFUSION MODELS

(71) Applicant: QUALCOMM Incorporated, San Diego, CA (US)

(72) Inventors: Riccardo DEL CHIARO, Amsterdam (NL); Marco FEDERICI, Diemen (NL); Boris VAN BREUGEL, Amsterdam (NL); Markus NAGEL, Amsterdam (NL)

(21) Appl. No.: 19/358,129

(22) Filed: Oct. 14, 2025

Related U.S. Application Data
(60) Provisional application No. 63/803,619, filed on May 10, 2025.

(51) Int. Cl. G06N 3/0495; G06N 3/045

(52) U.S. Cl. CPC G06N 3/0495; G06N 3/045

(57) ABSTRACT

Techniques and apparatus for improved machine learning. An example method generally includes applying an affine transform to an input activation matrix, the affine transform comprising a bias matrix, a first invertible matrix having a sequence length dimension, and a second invertible matrix having a feature dimension; quantizing the transformed input activation matrix; quantizing a fused weight matrix, the fused weight matrix being a first product of a weight matrix and an inverse of the second invertible matrix; multiplying the quantized transformed input activation matrix with the quantized fused weight matrix to generate a second product; multiplying an inverse of the first invertible matrix with the second product to generate a third product; multiplying the bias matrix with the weight matrix to generate a fourth product; outputting a sum of the third product and the fourth product; and generating an output of the diffusion model based on the sum.

### CROSS-REFERENCE TO RELATED APPLICATION(S)

The present application for patent claims the benefit of and priority to U.S. Provisional Application No. 63/803,619, filed May 10, 2025, and entitled “Quantization Enhancing Transformations for Diffusion Models,” which is incorporated by reference herein in its entirety for all applicable purposes.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using large language models (LLMs), large vison models (LVMs), latent diffusion models (LDMs), and the like to process and generate output data. However, many existing model architectures are large, having many parameters (e.g., millions or billions of parameters), and thus, exhibit slow inference times, coupled with high computation and memory demands, making such large models challenging to deploy on edge devices. That is, such models are often not able to be executed on computing devices having relatively limited resources, such as limited memory, limited processing power, limited battery, and the like (e.g., smartphones).

For example, diffusion models generally rely on performing a relatively large number of iterations or passes to iteratively generate output data (e.g., images, video, audio, text, and the like). Though this generative sampling can result in impressive output, the lengthy process significantly limits its practicality (particularly for computing devices with limited computational and/or power resources, such as smartphones). Some approaches to improve accessibility to machine learning (e.g., on edge devices with limited compute) include model quantization. Though quantization can reduce the model size substantially, quantization also introduces inherent error due to the fact that high-precision model parameters are approximated using lower-precision values.

### BRIEF SUMMARY

Certain aspects of the present disclosure provide a processor-implemented method for machine learning. The method generally includes applying an affine transform to an input activation matrix for a layer of a diffusion model to generate a transformed input activation matrix, the affine transform comprising a bias matrix, a first invertible matrix having a sequence length dimension, and a second invertible matrix having a feature dimension; quantizing the transformed input activation matrix to generate a quantized transformed input activation matrix; quantizing a fused weight matrix to generate a quantized fused weight matrix, the fused weight matrix being a first matrix product of a weight matrix and an inverse of the second invertible matrix; matrix multiplying the quantized transformed input activation matrix with the quantized fused weight matrix to generate a second matrix product; matrix multiplying an inverse of the first invertible matrix with the second matrix product to generate a third matrix product; matrix multiplying the bias matrix with the weight matrix to generate a fourth matrix product; outputting a sum of the third matrix product and the fourth matrix product as an output of the layer of the diffusion model; and generating, with the diffusion model, an output of the diffusion model, based at least in part on the output of the layer.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended FIGURES depict certain aspects of the present disclosure and are therefore not to be considered limiting of the scope of this disclosure.

FIG. 1 depicts an example workflow for image generation using a diffusion model, according to some aspects of the present disclosure.

FIG. 2 depicts example transforms for quantizing weights and activations in a diffusion model, according to some aspects of the present disclosure.

FIG. 3 is a table of example transforms for quantizing weights and activations in a diffusion model, according to some aspects of the present disclosure.

FIG. 4 is a visualization of using an example generalized affine transform (GAT) to calculate a matrix product of an input activation matrix and a weight matrix, according to some aspects of the present disclosure.

FIG. 5 is a block diagram depicting an example overview of transformations and other enhancements for U-Net-based diffusion models, according to some aspects of the present disclosure.

FIG. 6 is a block diagram depicting an example overview of transformations and other enhancements for diffusion transformer (DiT) models, according to some aspects of the present disclosure.

FIG. 7 is a flow diagram depicting an example method for diffusion machine learning, according to some aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques and apparatus for providing quantization enhancements (e.g., transformations and other features) for diffusion models are presented. These enhancements may reduce quantization outliers while minimizing (or at least reducing) the overhead to aggressively quantize diffusion model weights and activations and improve inference speed (e.g., image generation time), energy consumption, and/or memory usage. Such quantization enhancements may facilitate deployment of diffusion models on devices with limited computational resources.

Increasingly, quantization (e.g., post-training quantization) has been used as a valuable technique to reduce model size, latency, and power consumption for machine learning models. For example, these improvements are particularly useful for on-device deployment of models (such as diffusion models). That is, when machine learning models are used on relatively constrained devices (e.g., devices with limited computational resources such as memory and/or limited power, for example due to being powered by battery), such as edge devices, user equipment (UE), smartphones, laptops, and the like, reducing the size and expense of such models is particularly valuable (e.g., enabling such models to be deployed on devices that otherwise could not host the models).

Generally, quantization involves approximating an original (full-precision) value using a value that can be encoded using fewer bits. For example, a model having parameters stored as sixteen-bit floating-point (FP16 or float16) values may be quantized by approximating each weight using a four-bit integer. As another example, a model that represents activations (e.g., intermediate or internal values generated as input data is passed through the model) using sixteen-bit floating-point values may be quantized to represent this intermediate data using eight bits. That is, as used herein, quantizing a given operation or component of a machine learning model may include quantizing the parameters (e.g., reducing the bitwidth used to store the parameters of the operation), quantizing the activations (e.g., reducing the bitwidth used to store the input and/or output of the operation), or quantizing both the parameters and the activations.

Quantization introduces inherent error in model output, as approximating full-precision values using fewer bits introduces noise into the data. Generally, quantizing to smaller bitwidths (e.g., four bits) results in significant compute savings, but introduces more error than using larger bitwidths (e.g., eight bits). For example, many machine learning models have parameters that are distributed in a similar fashion to a normal distribution, but with a relatively long tail (e.g., outlier values). These outliers are difficult to effectively represent in quantized form (e.g., because the outliers dominate the range of the quantization, resulting in significant granularity error). In other words, such outliers can be represented by a large quantization grid, leading to large bins and loss of precision for the majority of the data. Some approaches involve removing such outliers to reduce the effective range of the quantization, but this outlier removal can also introduce substantial error.

### Example Workflow for Generating Images Using Diffusion Models

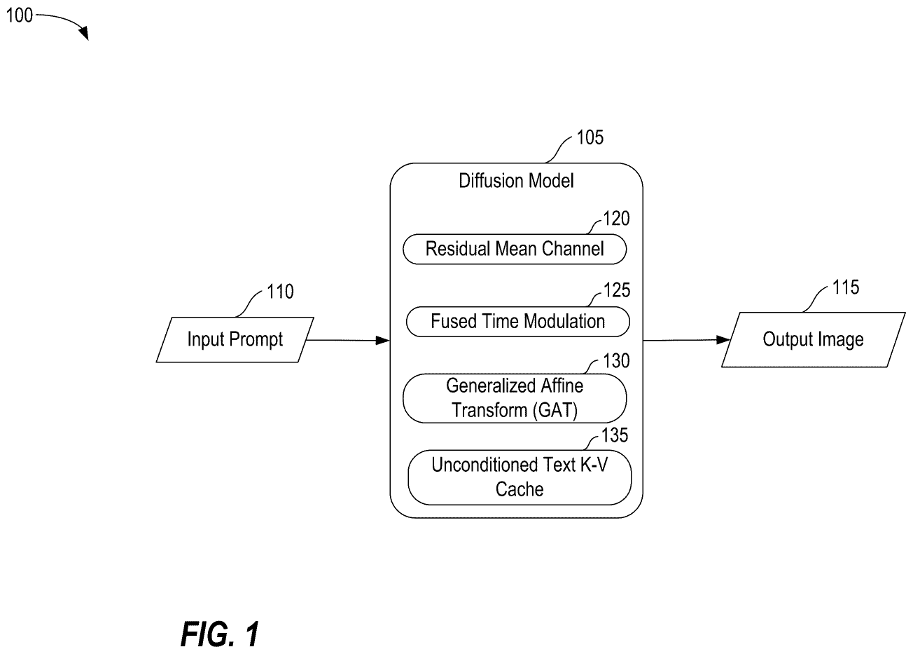

FIG. 1 depicts an example workflow 100 for image generation using a diffusion model 105, according to some aspects of the present disclosure. Although the present disclosure focuses on image generation as an example output of a diffusion model, it is to be understood that the output of the diffusion model may be any suitable output, such as an image, video, audio, text, three-dimensional (3D) data (e.g., a point cloud or mesh), a molecular structure, etc. The diffusion model 105 may be implemented by any computing system(s) capable of performing the operations discussed below, and may be implemented using hardware, software or a combination of hardware and software.

In the illustrated example, the diffusion model 105 accesses an input prompt 110. As used herein, “accessing” data may generally include receiving, requesting, retrieving, obtaining, collecting, generating, or otherwise gaining access to the data. For example, the diffusion model 105 may receive the input prompt 110 from a user or from a separate system (e.g., a machine learning system). The diffusion model 105 is generally representative of a machine learning model that uses a sequence of iterations or steps (referred to in some aspects as “time intervals”) to iteratively generate output data (e.g., images), such as via a learned denoising process (e.g., conditioned based on textual input). For example, the diffusion model 105 may represent a latent diffusion model (LDM). In some aspects, the diffusion model 105 may begin with a (random) noisy latent, and iteratively denoise the latent based on previous training (resulting in one or more denoised latents, referred to in some aspects as “processed output” and/or “processed images,” during each iteration). In some aspects, this diffusion process is guided via input conditioning (e.g., based on an input prompt 110, such as a text string or an image, indicating characteristics of the desired output image 115).

While diffusion models represent the cutting edge in deep learning for output (e.g., image) generation, there is substantial interest in optimizing the efficiency of inference with these models to facilitate scalability and enable deployment on devices with limited computational resources (e.g., portable devices, such as smartphones and laptops).

One way to optimize efficiency, in an effort to successfully operate diffusion models on a device, is weight and/or activation quantization. Changing from 16-bit floating-point data, for example, to 8-bit data or 4-bit data would drastically reduce the output (e.g., image) generation time, energy consumption, and memory usage of diffusion models. As described above, however, quantization introduces inherent error since high-precision values are approximated using lower-precision values. One of the biggest problems encountered in quantization of such diffusion models is the outliers. For example, naive 8-bit activation quantization (A8) leads to performance degradation due to such outliers. Activation quantization may be even more difficult for diffusion models because the generation process is iterative and quantization errors stack up. Some approaches focus on dynamic quantization, such that outliers in individual sequence elements are normalized online. However, such online calculations can reduce inference speed and increase power consumption in diffusion models.

Accordingly, certain aspects of the present disclosure provide enhancements to assist with quantization in diffusion models. Therefore, the diffusion model 105 may include one or more of the following features to assist with quantization: a residual mean channel feature 120, a fused time modulation feature 125, a generalized affine transform (GAT) feature 130, and/or an unconditioned text key-value (K-V) cache feature 135. These features are described in detail below.

### Example Residual Mean Channel

For general transformer architectures (including transformer-based diffusion models), there are some normalization layers (e.g., LayerNorm) that call for operating online. One problem with LayerNorm is that this normalization layer applies some shifting and rescaling, and if it is desired to quantize the output of a LayerNorm, this shifting and rescaling may involve applying a rotation right after the LayerNorm. However, this could be a problem because this rotation would be computed on the fly during the inference, which is computationally expensive, and then the activations could be quantized.

Instead of considering the original output of the matrix multiplication (matmul) before the LayerNorm, the output of the matmul can be split into two parts: a first part that is centered and a second part that is everything else (the residual mean along the feature dimensions, as described below). The idea is that the centered output and the residual mean can be treated separately throughout the architecture. Thus, the rotation can be applied and fused with the centered output, and this rotated centered output can be input into the LayerNorm. The residual mean is just put back into the architecture when the original signal is going to be computed.

To explain, any matrix operation can be written as the sum of a zero-centered component and some residual mean:

$$\begin{matrix}xW = xW ( M + \frac{{11}^{T}}{d} ) \\ = x ( WM ) + x ( \frac{w 1}{d} ) {1}^{T} \\ = x \hat{W} - x \overline{w} {1}^{T}\end{matrix}$$

where x is an input activation matrix, W is a weight matrix, M is a centering matrix, d is the number of input features of W, xŴ is the centered output, and xw̅1^{T} is the residual mean. The residual mean and centered output channels may be considered separately in the architecture.

LayerNorm blocks can be converted into root mean square (RMS) layer normalization (RMSNorm), which allows for fusing rotations into subsequent linear layers. Fusing the rotations into subsequent linear layers may minimize (or at least reduce) the overhead of the transformation, RMSNorm(xR)W, according to the following conversion:

RMSNorm(xR)W→RMSNorm(x̅)(RW)

where x is an input activation matrix, R is a rotation matrix, and RW is the rotated weights.

Keeping track of the residual mean allows for dealing with network components not preceded by a LayerNorm block. The residual mean may then be added to the centered output to reconstruct the original signal.

In LLMs, since there is another LayerNorm at the output, the residual mean is generally not important and can be discarded. With diffusion models, there is no LayerNorm at the end of the architecture, so the residual mean is determined, kept track of, and put back right at the end of the computation to get the original values. In other words, the idea is to keep track of what was removed to center the input and put this back when called for.

Removing the residual mean helps with fusing transformations, as described below, that are applied to remove the outliers. By doing this, the transformation operation can be merged into weights of the architecture, so computation overhead is reduced. If this trick is not used, this transformation operation will be applied on the fly during inference, which is computationally expensive.

### Example Fused Time Modulation

To produce an output (e.g., image) in a diffusion model, the same architecture is applied multiple times in sequence to start from noise and then get better and better until the final output is generated. Diffusion model architectures (e.g., transformer-based diffusion model architectures) introduce time-modulation layers that scale and translate the input channels in specific parts of the architecture. A time-modulation layer may be similar to LayerNorm in that such layers involve some scaling and shifting. However, if the activation is to be transformed after the scaling and shifting, a shift may first be performed, and then the weights may be rotated at runtime, which can be computationally expensive.

The time-modulation layers of diffusion model architectures prevent fusing rotations into the weights directly, since rotations and time modulations do not commute:

TimeModulation(xRR⁻¹,t)W≠TimeModulation(xR,t)R⁻¹W

The idea with fused time modulation is that the time-modulation operation can be fused into the following linear layer. The result is that the following linear layer (e.g., the weight matrix W) would be time dependent because this time modulation changes with the time step of the diffusion process. This time-modulation layer has a different value for each one of these intermediate steps. But if this time modulation is fused into the weights, which are constant with time, this time dependency is placed into the weights. Such time-dependent weights could be computed for each time step on the fly with low overhead. This also allows for fusing the transformation (e.g., rotation matrix R) into the weights.

Therefore, the time-modulation layer may instead be fused into the following linear layer, together with the rotation matrix R:

$$\begin{matrix}TimeModulation ( {xRR}^{- 1} , t ) W = ( {xRR}^{- 1} Diag ( {γ}_{t} ) + {β}_{t} ) W \\ = x ( {R}^{- 1} Diag ( {γ}_{t} ) W ) + {β}_{t} W \\ = \overline{x} {W}_{t}^{γ} + {b}_{t}\end{matrix}$$

where the fusion of xR can be quantized to represent quantized activations and where the fusion of R⁻¹Diag(γₜ)W can be quantized to represent quantized weights. The matrix product xR has fewer outliers compared to the input activation matrix x when quantized.

Similarly, output time modulation can be fused into the previous linear layer as follows:

$$OutTimeModulation ( {xRR}^{- 1} W , t ) = xR ( {R}^{- 1} W Diag ( {δ}_{t} ) ) = {xW}_{t}^{δ}$$

where the fusion of xR can be quantized to represent quantized activations and where the fusion of R⁻¹WDiag(δₜ) can be quantized to represent quantized weights. γₜ, βₜ, and δₜ are time-modulation vectors.

This operation introduces weights that vary with the time step. In some aspects, weights for all time steps can be precomputed and cached in memory or computed on the fly. To be clear, the fused time modulation does not help to remove outliers; rather, this modulation helps in fusing an operation (e.g., R) that does remove the outliers. The cost of the fused time modulation is that either: (i) the weights for each time step are computed on the fly and quantized or (ii) the quantized weight for all the time steps may be computed and stored beforehand.

### Example Generalized Affine Transforms for Enhancing Quantization in Diffusion Models

One approach to reduce outliers and consequently improve quantization is to apply invertible transformations to weights and activations, which do not alter the overall model output, but which do allow scaling outlier channels.

Consider a matrix x of shape [sequence length, features], as found in transformer blocks. That is, the sequence length is the first dimension of this matrix, and the number of features is the second dimension. Sequence length can be variable in language models but is typically constant in diffusion models. The sequence length dimension generally refers to the number of elements (e.g., tokens, patches, pixels, or time steps) that are in a sequence processed by the diffusion model. In a U-Net diffusion model, the sequence length dimension generally corresponds to spatial positions in a feature map, whereas in a transformer-based diffusion model, the sequence length dimension generally corresponds to the number of patches (or tokens) in the latent or image space. The feature dimension generally refers to the size of the vector (embedding) describing each element in the sequence. In a U-Net diffusion model, the feature dimension generally corresponds to a number of channels at a given layer, whereas in a transformer-based diffusion model, the feature dimension generally corresponds to a hidden size.

A generalized affine transform (GAT) of x can be defined as

x̅=GAT(x̅)=S(x−B)V

in which S and V are invertible matrices of shape [sequence length, sequence length] and [features, features], respectively. B is a bias matrix having dimensions [sequence length, features]. With this transformation, x can be shifted with B, and the shifted result can be multiplied with the feature dimension by a rotation or any invertible matrix V. The sequence dimension is also considered with matrix S to generalize this. Matrices can be multiplied on the sequence dimension as long as these matrices are invertible. If these matrices S and V are invertible, then from x, original input x can be recovered by applying an inverse operation. In other words, there is a way to transform x by shifting, rescaling, and rotating x on both feature and sequence dimensions and then to get back from there. The inverse transformation is defined as

x=S⁻¹x̅V⁻¹+B

Any x can be replaced with this expression.

Generalized affine transforms described herein differ from affine feature transforms in other approaches because of the additional transformation S that is applied on the sequence dimension. Furthermore, a multi-dimensional matrix B is used to define the offset instead of a vector (a one-dimensional matrix).

Using the GAT, a matrix multiplication (matmul)xW between x and a weight matrix W can be written as

xW=S⁻¹(x̅(V⁻¹W)+BW

Note that the inverse matrix V⁻¹ can be fused into the weight matrix, while the matmul with the inverse matrix S⁻¹ and the addition of the matrix product BW may most likely be computed at inference time. The GAT allows transformation of x and W before performing the quantized matrix multiplication according to the following expression:

xW≈S⁻¹(Q(x̅)Q(V₋₁W))+BW

where Q(x̅) represents the quantized activations, Q(V⁻¹W) represents the quantized fused weights, and where S⁻¹ and BW are operations to be performed online.

How matrices S, B, and/or V are defined can be exploited to make x̅ easier to quantize. Then, the original x can be restored by applying the inverse transformation, which can be partially fused again into the weights.

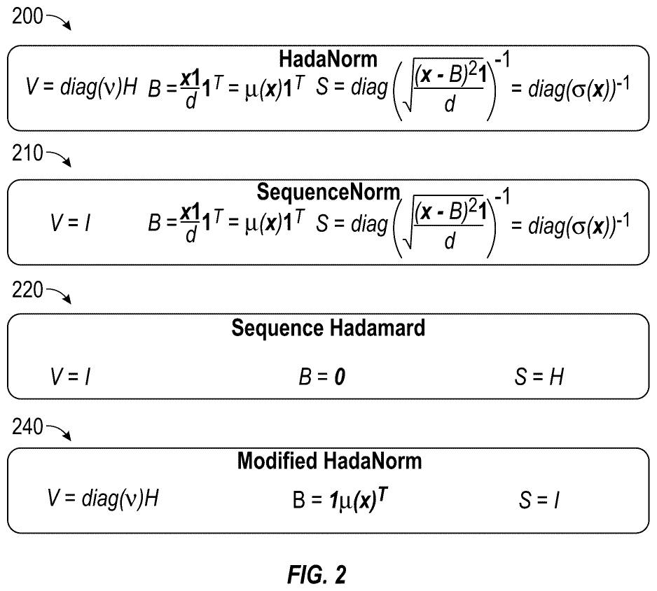

FIG. 2 depicts example transforms for quantizing weights and activations x in a diffusion model, according to certain aspects of the present disclosure. These example transforms include HadaNorm, SequenceNorm, and Sequence Hadamard.

HadaNorm is an example of a GAT and is illustrated in block 200. HadaNorm first normalizes each sequence element (analogously to batch normalization) and then applies a Hadamard rotation with a Hadamard matrix H. Normalizing improves quantization but does not mix channels. Hence, normalizing cannot get rid of heavy tails. A Hadamard transform may be used to mix channels, thereby spreading outliers over multiple channels, but may suffer when the channels have different means. The HadaNorm achieves better performance (e.g., whitening), by first normalizing and then applying the Hadamard transform.

The HadaNorm transformation is achieved by defining matrices V, B, and S as shown in block 200. In block 200, the invertible matrix S comprises an inverse of a diagonal matrix with a scaling value (e.g., Diag(σ(x̅))⁻¹). In this example, the scaling value is based at least in part on a standard deviation of a column of the input activation matrix (e.g., σ(x̅)) and d is the total number of elements (features) in the activation matrix x. The bias matrix B comprises a vector multiplied by a transposed all-ones matrix (e.g., 1^{T}). In this example, the vector is a mean vector representing an average over a sequence dimension of the input activation matrix (e.g., μ(x̅)), but other values could be used. The invertible matrix V comprises a Hadamard matrix (H) rescaled by a diagonal matrix with a constant factor (e.g., diag(v)). In some aspects, for example, the constant vector v may be selected as the inverse activation standard deviation over some calibration set. With these definitions, the HadaNorm transform is basically rescaling on the sequence dimension and rotating on features.

A simplified version of HadaNorm named SequenceNorm is illustrated in block 210. Matrices B and S are defined to be the same in SequenceNorm as in HadaNorm, whereas V is an identity matrix I in SequenceNorm.

The sequence element mean (μ(x̅)) and scale (σ(x̅)) can be either computed dynamically or learned as static vectors. HadaNorm and SequenceNorm are effective at reducing the matmul quantization error with minimal (or at least reduced) overhead on the inference time.

Another GAT example includes Sequence Hadamard (SH), which is portrayed in block 220. Sequence Hadamard applies a Hadamard rotation to the sequence dimension by defining matrices V, B, and S as an identity matrix I, a zero matrix 0, and a Hadamard matrix H, respectively, as shown in block 220. Rotating in the sequence dimension is typically not done for LLMs and is more applicable to diffusion models. Applying the Sequence Hadamard transform is a relatively simple operation. For example, the B matrix is 0, so is essentially not used, and the V is an identity matrix I.

The Sequence Hadamard transform is particularly effective in the attention matrix multiplication, for example, when applied to batched matrix multiplication (BMM) commonly used in attention blocks. When multiplying the attention weights A by the values v, the Sequence Hadamard transform can be used to apply a Hadamard rotation in the sequence dimension. For example, the matrix product can be expressed as

Av=(AH^{T})(Hv)≈Q(AH^{T})Q(Hv)

where the rotated attention weights AH^{T} can be quantized (as the quantized attention weights Q(AH^{T})) and where the rotated values Hv can be quantized (as the quantized values Q(Hv)). By applying the Hadamard rotation to the values and the transposed Hadamard rotation to the attention weights, the rotations will cancel out. With the Sequence Hadamard transform applied in the case of attention matmul, the rotated activation weights and the rotated values are quantized on the sequence dimension. This performs much better than just quantizing directly, especially since the activation weights are quite sensitive to quantization noise. In this manner, the sensitivity is significantly lowered.

A modified version of HadaNorm named Modified HadaNorm is illustrated in block 240. Matrix V is defined to be the same in Modified HadaNorm as in HadaNorm, whereas matrix S is an identity matrix I in Modified HadaNorm. Also in Modified HadaNorm, the bias matrix B comprises an all-ones matrix multiplied by the transpose of a vector. In this example, the vector is a mean of the input activation matrix (e.g., μ(x̅)) and represents the average over the sequence dimension of the activation matrix x, but other values could be used. The HadaNorm and Modified HadaNorm transformations apply centering and rescaling of channels prior to a Hadamard transformation to further improve performance of activation quantization. In the Modified HadaNorm, the normalization (B) is applied to each channel for all tokens, rather than to each token for all channels as with HadaNorm.

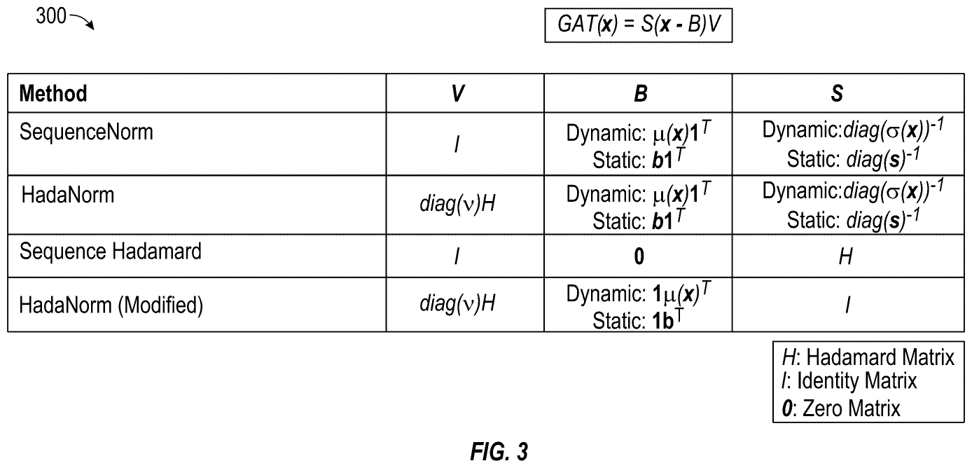

FIG. 3 is a table 300 of example transforms for quantizing weights and activations in a diffusion model, according to some aspects of the present disclosure. This table 300 allows for comparison between the four example transforms provided in FIG. 2 and described above. The reader will note that the S matrix is not an identity matrix for any of these transforms, with the exception of the Modified HadaNorm. It is to be understood that transforms other than those shown in table 300 may be used. For example, the example transforms may be combined, use a different bias definition, use different feature rotations, etc.

### Example Visualization of Using a GAT

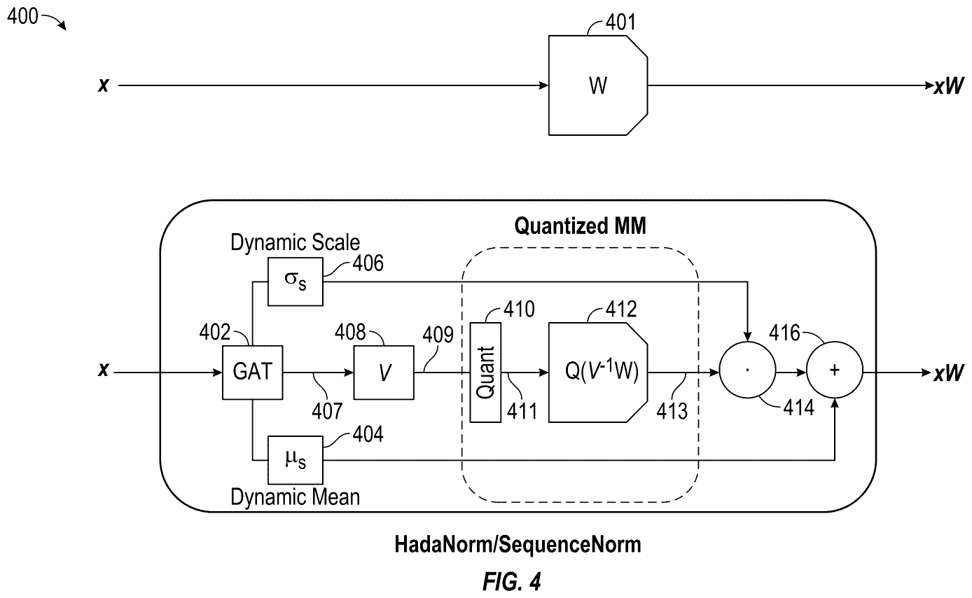

FIG. 4 is a visualization 400 of using an example generalized affine transform (GAT) 402 to generate a matrix product of an input activation matrix x and a weight matrix W 401, according to some aspects of the present disclosure.

Initially, the GAT 402 is applied to the matrix x. As shown here, a HadaNorm or SequenceNorm transform is used, but other affine transforms may be applied. A mean (μₛ) 404 for centering and a scale (σₛ) 406 for scaling may be determined. The mean 404 and scale 406 can each be computed dynamically or can be static (e.g., a static vector). In the dynamic version, the dynamic mean and dynamic scale would be computed. The mean 404 and scale 406 may be removed as shown in FIG. 4 to center the output of the shifting and scaling and kept for later use, as described below. The centered output at 407 may be transformed in the feature dimension (using a V matrix 408 as indicated) to generate the activation matrix x̅ at 409. The activation matrix x̅ may be quantized at 410 to generate Q(x̅) at 411. The weights are transformed with V⁻¹, which is fused into the weights, and quantized to form Q(V⁻¹W) at 412 as shown. The quantized activation matrix and the quantized fused weights matrix may be matrix multiplied to generate a matrix product Q(x̅)Q(V⁻¹W) at 413.

Two online operations (a matrix multiplication at 414 with matrix S⁻¹ and an addition at 416 with the matrix product BW) may be applied to the matrix product Q(x̅)Q(V⁻¹W). The multiplication with S⁻¹ in the sequence dimension may be just elementwise rescaling because S⁻¹ is a diagonal matrix in the HadaNorm or SequenceNorm transform. As illustrated, in the case of using the HadaNorm or SequenceNorm transform as the GAT 402, inverted matrix S⁻¹ may be based on the scale 406. Then, the bias is added, which is a vector addition (of BW) to the activations. If instead we have a static bias, the matrix multiplication BW need not be computed on the fly, because BW can be precomputed. As illustrated, in the case of using a HadaNorm or SequenceNorm transform as the GAT 402, the bias matrix B and the matrix product BW may be based on the mean 404.

This transformation can be effectively wrapped around any linear layer. Such a dynamic centering transformation can be combined with other techniques to further reduce quantization error.

### Example Unconditioned Text K-V Cache

Some LVMs use classifier-free guidance to produce text conditional image samples. This technique involves computing the score of both conditional and unconditional denoising models. Unconditional denoising scores are obtained by conditioning the model with an empty textual embedding T₀. As a result, half of the conditional textual embeddings in each batch at inference time consist of c₀, which is used to determine the keys and values in cross-attention layers. This operation not only wastes compute to perform the same matrix multiplications multiple times, but also introduces issues when quantizing the textual embeddings since c₀ has a different scale compared to the non-empty textual embeddings. For this reason, the keys K₀ and values V₀ corresponding to the empty embedding T₀ may be precomputed and only the non-empty embeddings T₁ may be quantized:

Cross-Attn(X, T)=concatenate-batch (Cross-Attn(X₀, T₀), Cross-Attn(X₁, T₁)) in which X₀ and X₁ refer to the hidden states corresponding to T₀ and T₁, respectively.

### Example Diffusion Models with Quantization Enhancements

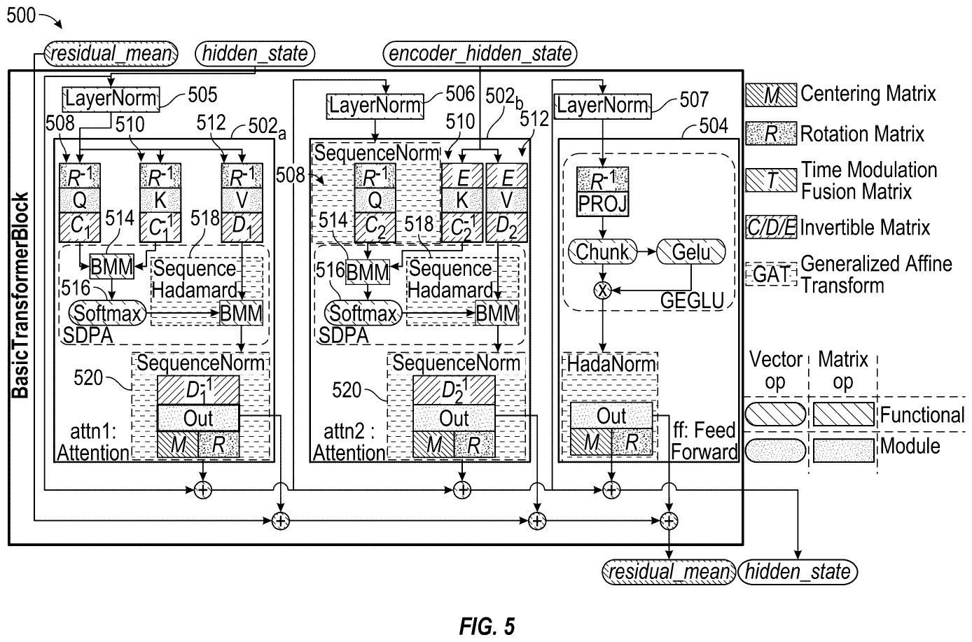

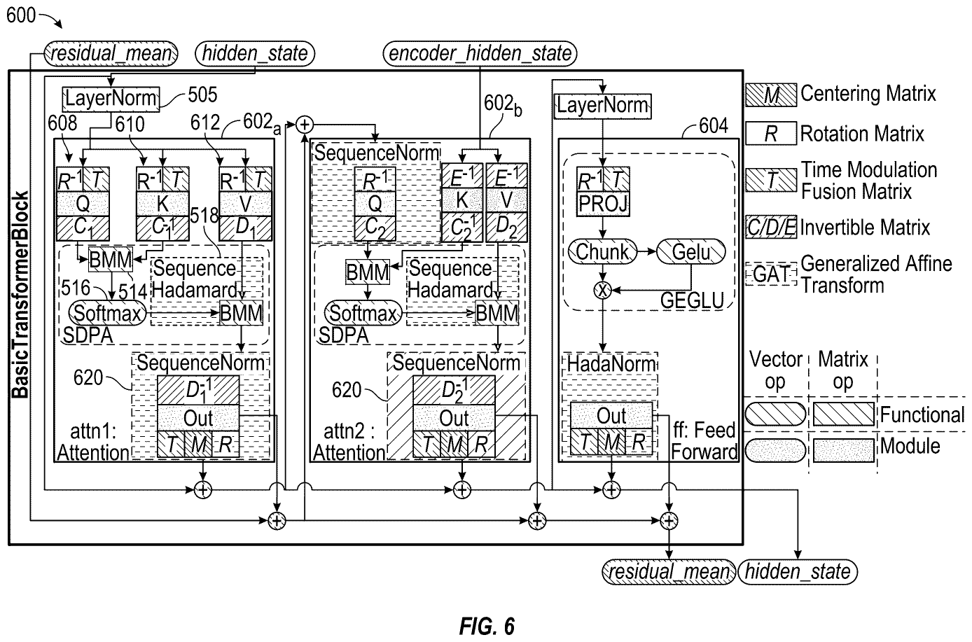

FIG. 5 is a block diagram 500 depicting an example overview of transformations and other enhancements for U-Net-based diffusion models, according to some aspects of the present disclosure. FIG. 6 is a block diagram 600 depicting an example overview of transformations and other enhancements for diffusion transformer (DiT) models, according to some aspects of the present disclosure.

The residual mean channel, the fused time modulation (with time modulation fusion matrix T), and the generalized affine transforms (e.g., Sequence Hadamard, SequenceNorm, HadaNorm, and Modified HadaNorm), as described above, can be seen in the block diagrams 500, 600 of these diffusion models. As described above, the residual mean channel may keep track of the extra non-centered signal for adding back in at the end of the architecture. The centering matrix M for the residual mean channel (e.g., the residual mean channel feature 120 of FIG. 1) and the rotation matrix R (and its inverse R⁻¹) for the fused time modulation (e.g., in the fused time modulation feature 125 of FIG. 1) are also depicted. Matrices C, D, and E are invertible matrices for multiplication on the feature dimension for feature transformations. Matrices C, D, and E can be fused directly, without online transformation.

The unconditioned text K-V cache may be applied for the K and V blocks. In the diffusion model architectures, one conditional part may be using the encoder hidden state, whereas the K and V can be cached instead for the other part. But in the block diagrams 500, 600, only the conditional part is represented, for simplicity.

The U-Net diffusion model has a slightly different architecture than the DiT model. For example, the residual mean may be reinserted in different places in the two different architectures, although the concept is the same. The time modulation block is fused into the weights, together with the inverse rotation matrix R⁻¹ in the DiT model, which is a time-dependent model, with different weights across different time steps. This fusion involves an online computation. However, without this time modulation fusion, the rotation here would also be unfused, would be applied before LayerNorm as an online operation, and would occur before the respective linear modification.

More specifically, the block diagram 500 of FIG. 5 illustrates the bottleneck of a U-Net-based diffusion model but does not show the encoder before the bottleneck (which receives the input text and/or image) or the decoder after the bottleneck (which generates the output (e.g., an image)). As shown in FIG. 5, the bottleneck includes multiple attention blocks 502a, 502b (collectively referred to herein as “attention blocks 502”) and a feed forward layer 504 after the attention blocks. A LayerNorm 505, 506, and 507 may precede the attention block 502a, the attention block 502b, and the feed forward layer 504, respectively and may receive a hidden state as an input. This hidden state may have the residual mean removed and set aside, as shown, such that the hidden state is a centered output.

Each attention block 502 includes a query (Q) block 508, a key (K) block 510, and a value (V) block 512. The output of the LayerNorm 505, 506 may be fused with inverted rotation matrix R⁻¹ and may be linearly projected to Q, K, and V values for blocks 508, 510, 512, respectively. The Q values in block 508 may be fused with matrix C₁ (or C₂), the K values in block 510 may be fused with inverted matrix C₁⁻¹ (or C₂⁻¹), and the V values in block 512 may be fused with matrix D₁ (or D₂). In batch matrix multiplication (BMM) block 514, the output of block 508 may be batch multiplied with the transpose of the output from block 510 (e.g., a scaled dot product attention (SDPA) of Q·K^{T}). In this manner, matrices C and C⁻¹ cancel out. A softmax function 516 may be applied to the output of the BMM block 514, and a transformation block 518 (e.g., a GAT, such as Sequence Hadamard) as described above may be applied to the output of the softmax function 516 and the V values to effectively perform a BMM (e.g., softmax (Q·K^{T})·V). The output of the transformation block 518 may be applied to another transformation block 520 (e.g., a GAT, such as Sequence Hadamard) as described above. The transformation block 520 may apply the inverse of the matrix (D₁⁻¹ (or D₂⁻¹)) applied to the V values, as shown. A centering matrix M and a rotation matrix R may be applied to the output of the transformation in the transformation block 520.

The output of the attention blocks 502 or the feedforward layer 504 may be added to the residual mean to generate a new residual mean at the output of each block/layer, as shown. As described above, treating the residual mean in this manner avoids having to compute the rotation for the residual mean on the fly, saving computation expense. The residual mean can be put back into the architecture when the output is going to be computed.

The block diagram 600 of FIG. 6 for DiT models is very similar to the block diagram of FIG. 5 for U-Net-based diffusion models, so only the differences will be described.

As shown in FIG. 6, the DiT architecture includes multiple attention blocks 602a, 602b (collectively referred to herein as “attention blocks 602”) and a feed forward layer 604 after the attention blocks 602. Each attention block 602 includes a query (Q) block 608, a key (K) block 610, and a value (V) block 612. The output of the LayerNorm 505 may be fused with inverted rotation matrix R⁻¹ and a time modulation fusion matrix T and may be linearly projected to Q, K, and V values for blocks 608, 610, 612, respectively. In transformation block 620, a time modulation fusion matrix T, a centering matrix M, and a rotation matrix R may be applied to the output of the transformation in the transformation block 620. The main difference is the addition of matrix T to the DiT architecture.

### Example Method for Machine Learning

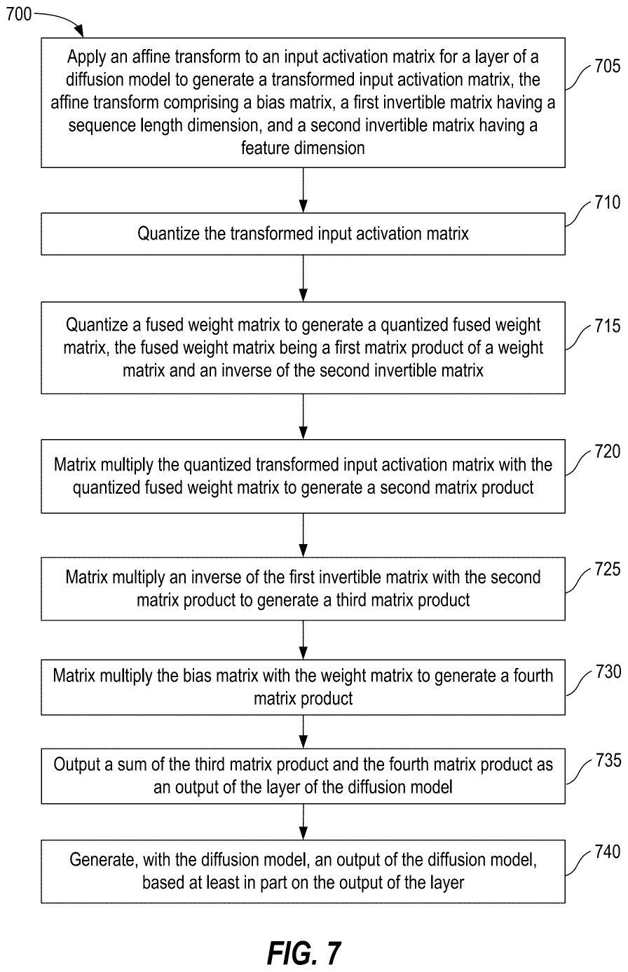

FIG. 7 is a flow diagram depicting an example method 700 for machine learning, according to some aspects of the present disclosure. In some aspects, the method 700 is performed by a diffusion model or other machine learning system, such as the diffusion model 105 of FIG. 1 and/or the diffusion models discussed above with reference to FIGS. 2-6.

The method 700 may begin, at block 705, with the machine learning system applying an affine transform (e.g., a GAT) to an input activation matrix (e.g., matrix x) for a layer of a diffusion model to generate a transformed input activation matrix (e.g., matrix x). The affine transform may include a bias matrix (e.g., matrix B), a first invertible matrix (e.g., matrix S) having a sequence length dimension, and a second invertible matrix (e.g., matrix V) having a feature dimension. In some aspects, the bias matrix has a sequence length dimension and a feature dimension.

At block 710, the machine learning system may quantize the transformed input activation matrix to generate a quantized transformed input activation matrix (e.g., Q(x̅)).

At block 715, the machine learning system may quantize a fused weight matrix (e.g., V⁻¹W) to generate a quantized fused weight matrix (e.g., Q(V⁻¹W)). The fused weight matrix may be a first matrix product of a weight matrix (e.g., weight matrix W) and an inverse of the second invertible matrix (e.g., matrix V⁻¹).

At block 720, the machine learning system may matrix multiply the quantized transformed input activation matrix with the quantized fused weight matrix to generate a second matrix product (e.g., Q(x̅)Q(V⁻¹W))

At block 725, the machine learning system may matrix multiply an inverse of the first invertible matrix (e.g., matrix S⁻¹) with the second matrix product to generate a third matrix product (e.g., S⁻¹ (Q(x̅)Q(V⁻¹W))).

At block 730, the machine learning system may matrix multiply the bias matrix with the weight matrix to generate a fourth matrix product (e.g., BW).

At block 735, the machine learning system may output a sum (e.g., S⁻¹(Q(x̅)Q(V⁻¹W))+BW) of the third matrix product and the fourth matrix product as an output of the layer of the diffusion model.

At block 740, the machine learning system may generate, with the diffusion model, an output (e.g., the output image 115 of FIG. 1) of the diffusion model based at least in part on the output of the layer from block 735. For example, the diffusion model may iteratively denoise the output (e.g., a latent) in several steps to generate the output of the diffusion model, as described above. The output of the diffusion model may include, for example, an image, video, audio, text, three-dimensional (3D) data (e.g., a point cloud or mesh), a molecular structure, etc. An input prompt (e.g., input prompt 105 of FIG. 1) may guide this iterative process to generate the output using the diffusion model.

According to certain aspects, the first invertible matrix is not an identity matrix (S≠I).

According to certain aspects, the first invertible matrix comprises an inverse of a diagonal matrix with a scaling value (e.g., Diag(σ(x̅))⁻¹), the bias matrix comprises a vector multiplied by a transposed all-ones matrix (e.g., 1^{T}), and the second invertible matrix comprises a Hadamard matrix (H) rescaled by a diagonal matrix with a constant factor (e.g., diag(v)). This may be referred to as the HadaNorm transformation, as described above and shown in block 200 of FIG. 2. In some aspects, the scaling value is based in part on a standard deviation of a column of the input activation matrix (e.g., σ(x̅)). Additionally or alternatively, in some aspects, the vector is a mean vector representing an average over a sequence dimension of the input activation matrix (e.g., μ(x̅)).

According to certain aspects, the first invertible matrix comprises an identity matrix (e.g., S=I), the bias matrix comprises an all-ones matrix (e.g., 1) multiplied by a transpose of a vector, and the second invertible matrix comprises a Hadamard matrix (H) rescaled by a diagonal matrix with a constant factor (e.g., diag(v)). This may be referred to as the Modified HadaNorm transformation, as described above and shown in block 240 of FIG. 2. In some aspects, the vector is a mean vector representing an average over a sequence dimension of the input activation matrix (e.g., μ(x̅)).

According to certain aspects, the first invertible matrix comprises an inverse of a diagonal matrix with a scaling value (e.g., Diag(σ(x̅))⁻¹), the bias matrix comprises a vector multiplied by a transposed all-ones matrix (e.g., 17), and the second invertible matrix comprises an identity matrix (e.g., V=I). This may be referred to as the SequenceNorm transformation, as described above and shown in block 210 of FIG. 2. In some aspects, the scaling value is based in part on a standard deviation of a column of the input activation matrix (e.g., σ(x̅)). Additionally or alternatively, in some aspects, the vector is a mean vector representing an average over a sequence dimension of the input activation matrix (e.g., μ(x̅)).

According to certain aspects, the first invertible matrix comprises a Hadamard matrix (e.g., S=H), the bias matrix comprises a zero matrix (e.g., B=0), and the second invertible matrix comprises an identity matrix (e.g., V=I). This may be referred to as the Sequence Hadamard transformation, as described above and shown in block 220 of FIG. 2.

According to certain aspects, the diffusion model is implemented by a diffusion transformer, and the layer is part of an attention block of the diffusion transformer. In this case, the first invertible matrix may include a Hadamard matrix (e.g., S=H), the bias matrix may be a zero matrix (e.g., B=0), and the second invertible matrix may be an identity matrix (e.g., V=I)

According to certain aspects, the input activation matrix is a zero-centered component matrix. In this case, the method 700 may further involve the machine learning system (i) keeping track of a residual mean removed from an initial activation matrix to generate the zero-centered component matrix and (ii) adding the residual mean to the output of the layer.

According to certain aspects, the method 700 may further include the machine learning system fusing a time modulation for the diffusion model into an initial weight matrix, together with an inverse rotation matrix, to generate the weight matrix, such that the weight matrix varies with time steps in the diffusion model.

According to certain aspects, the machine learning system applying the affine transform at block 705 may involve the machine learning system determining a mean (e.g., μ(x̅)) and a scale (e.g., σ(x̅)) of the input activation matrix (e.g., matrix x). In this case, the first invertible matrix may be based on the scale, and/or the bias matrix may be based on the mean. In some aspects, the mean may be a dynamic mean (as opposed to a static mean), and/or the scale may be a dynamic scale (as opposed to a static scale).

### Example Processing System for Machine Learning

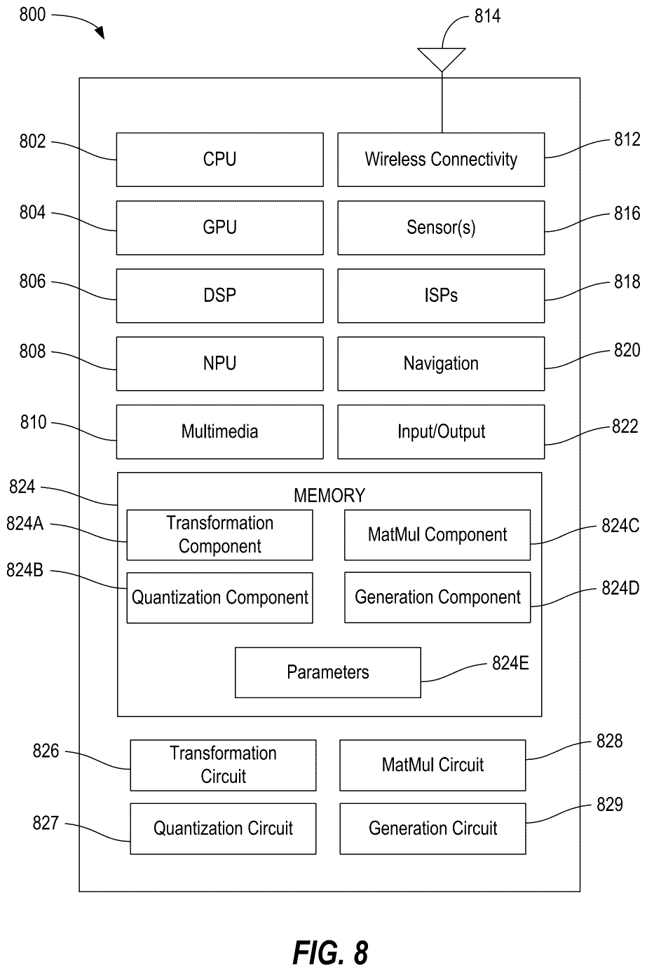

FIG. 8 depicts an example processing system 800 configured to perform various aspects of the present disclosure, including, for example, the techniques and methods described with respect to FIGS. 1-7. In some aspects, the processing system 800 may correspond to a diffusion model or other machine learning system. For example, the processing system 800 may correspond to the diffusion model 105 of FIG. 1 and/or the diffusion models discussed above with reference to FIGS. 2-7. Although depicted as a single system for conceptual clarity, in some aspects, as discussed above, the components described below with respect to the processing system 800 may be distributed across any number of devices or systems.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of a memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as the NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes a memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a transformation component 824A, a quantization component 824B, a matrix multiplication (matmul) component 824C, and a generation component 824D. Although not depicted in the illustrated example, the memory 824 may also include other components. Though depicted as discrete components for conceptual clarity in FIG. 8, the illustrated components (and others not depicted) may be collectively or individually implemented in various aspects. As illustrated, the memory 824 also includes a set of parameters 824E (e.g., weights).

The processing system 800 further comprises a transformation circuit 826, a quantization circuit 827, a matmul circuit 828, and a generation circuit 829. The depicted circuits, and others not depicted, may be configured to perform various aspects of the techniques described herein.

The transformation component 824A and/or the transformation circuit 826 may be used to apply a transform (e.g., a GAT) to an input activation matrix, as discussed above. For example, the transformation component 824A and/or the transformation circuit 826 may generate a transformed input activation matrix (x̅).

The quantization component 824B and/or the quantization circuit 827 may be used to quantize the transformed input activation matrix or a fused matrix, such as a fused weight matrix (e.g., V⁻¹W), as discussed above. The matmul component 824C and/or the matmul circuit 828 may be used to perform matrix multiplication, as discussed above. The generation component 824D and/or the generation circuit 829 may be used to perform diffusion-based generative machine learning, as discussed above.

Though depicted as separate components and circuits for clarity in FIG. 8, the transformation circuit 826, the quantization circuit 827, the matmul circuit 828, and the generation circuit 829 may collectively or individually be implemented in other processing devices of the processing system 800, such as within the CPU 802, the GPU 804, the DSP 806, the NPU 808, and the like.

Generally, the processing system 800 and/or components thereof may be configured to perform the methods described herein.

Notably, in other aspects, elements of the processing system 800 may be omitted, such as where the processing system 800 is a server computer or the like. For example, the multimedia component 810, the wireless connectivity component 812, the sensor processing units 816, the ISPs 818, and/or the navigation processor 820 may be omitted in other aspects. Further, elements of the processing system 800 may be distributed between multiple devices.

### Example Clauses

Implementation examples are described in the following numbered clauses:

Clause 1: A processor-implemented method for machine learning, comprising: applying an affine transform to an input activation matrix for a layer of a diffusion model to generate a transformed input activation matrix, the affine transform comprising a bias matrix, a first invertible matrix having a sequence length dimension, and a second invertible matrix having a feature dimension; quantizing the transformed input activation matrix to generate a quantized transformed input activation matrix; quantizing a fused weight matrix to generate a quantized fused weight matrix, the fused weight matrix being a first matrix product of a weight matrix and an inverse of the second invertible matrix; matrix multiplying the quantized transformed input activation matrix with the quantized fused weight matrix to generate a second matrix product; matrix multiplying an inverse of the first invertible matrix with the second matrix product to generate a third matrix product; matrix multiplying the bias matrix with the weight matrix to generate a fourth matrix product; outputting a sum of the third matrix product and the fourth matrix product as an output of the layer of the diffusion model; and generating, with the diffusion model, an output of the diffusion model based at least in part on the output of the layer.

Clause 2: The processor-implemented method according to Clause 1, wherein the first invertible matrix is not an identity matrix.

Clause 3: The processor-implemented method according to Clause 1 or 2, wherein the first invertible matrix comprises an inverse of a diagonal matrix with a scaling value, wherein the bias matrix comprises a vector multiplied by a transposed all-ones matrix, and wherein the second invertible matrix comprises a Hadamard matrix rescaled by a diagonal matrix with a constant factor.

Clause 4: The processor-implemented method according to Clause 3, wherein the scaling value is based in part on a standard deviation of a column of the input activation matrix and wherein the vector is a mean vector representing an average over a sequence dimension of the input activation matrix.

Clause 5: The processor-implemented method according to Clause 1 or 2, wherein the first invertible matrix comprises an inverse of a diagonal matrix with a scaling value, wherein the bias matrix comprises a vector multiplied by a transposed all-ones matrix, and wherein the second invertible matrix comprises an identity matrix.

Clause 6: The processor-implemented method according to Clause 1 to 2, wherein the first invertible matrix comprises a Hadamard matrix, wherein the bias matrix comprises a zero matrix, and wherein the second invertible matrix comprises an identity matrix.

Clause 7: The processor-implemented method according to any of Clauses 1 to 6, wherein the diffusion model is implemented by a diffusion transformer and wherein the layer is part of an attention block of the diffusion transformer.

Clause 8: The processor-implemented method according to any of Clauses 1 to 7, wherein the input activation matrix is a zero-centered component matrix, the method further comprising: keeping track of a residual mean removed from an initial activation matrix to generate the zero-centered component matrix; and adding the residual mean to the output of the layer.

Clause 9: The processor-implemented method according to any of Clauses 1 to 8, further comprising fusing a time modulation for the diffusion model into an initial weight matrix, together with an inverse rotation matrix, to generate the weight matrix, such that the weight matrix varies with time steps in the diffusion model.

Clause 10. The processor-implemented method according to any of Clauses 1 to 9, wherein the bias matrix has a sequence length dimension and a feature dimension.

Clause 11: The processor-implemented method according to any of Clauses 1 to 10, wherein applying the affine transform comprises determining a mean and a scale of the input activation matrix, wherein the first invertible matrix is based on the scale and wherein the bias matrix is based on the mean.

Clause 12: The processor-implemented method according to Clause 11, wherein the mean is a dynamic mean and wherein the scale is a dynamic scale.

Clause 13: A processing system comprising: at least one memory comprising executable instructions; and one or more processors configured to execute the executable instructions and cause the processing system to perform a method in accordance with any of Clauses 1-12.

Clause 14: A mobile device comprising the processing system of Clause 13.

Clause 15: A processing system comprising means for performing a method in accordance with any of Clauses 1-12.

Clause 16: A non-transitory computer-readable medium comprising computer-executable instructions that, when executed by one or more processors of a processing system, cause the processing system to perform a method in accordance with any of Clauses 1-12.

Clause 17: A computer program product embodied on a computer-readable storage medium comprising code for performing a method in accordance with any of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in FIGURES, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors coupled to the one or more memories and configured to execute the processor-executable instructions and cause the processing system to:
apply an affine transform to an input activation matrix for a layer of a diffusion model to generate a transformed input activation matrix, the affine transform comprising a bias matrix, a first invertible matrix having a sequence length dimension, and a second invertible matrix having a feature dimension;
quantize the transformed input activation matrix to generate a quantized transformed input activation matrix;
quantize a fused weight matrix to generate a quantized fused weight matrix, the fused weight matrix being a first matrix product of a weight matrix and an inverse of the second invertible matrix;
matrix multiply the quantized transformed input activation matrix with the quantized fused weight matrix to generate a second matrix product;
matrix multiply an inverse of the first invertible matrix with the second matrix product to generate a third matrix product;
matrix multiply the bias matrix with the weight matrix to generate a fourth matrix product;
output a sum of the third matrix product and the fourth matrix product as an output of the layer of the diffusion model; and
generate, with the diffusion model, an output of the diffusion model, based at least in part on the output of the layer.

2. The processing system of claim 1, wherein the first invertible matrix is not an identity matrix.

3. The processing system of claim 1, wherein the first invertible matrix comprises an inverse of a diagonal matrix with a scaling value, wherein the bias matrix comprises a vector multiplied by a transposed all-ones matrix, and wherein the second invertible matrix comprises a Hadamard matrix rescaled by a diagonal matrix with a constant factor.

4. The processing system of claim 3, wherein the scaling value is based in part on a standard deviation of a column of the input activation matrix and wherein the vector is a mean vector representing an average over a sequence dimension of the input activation matrix.

5. The processing system of claim 1, wherein the first invertible matrix comprises an inverse of a diagonal matrix with a scaling value, wherein the bias matrix comprises a vector multiplied by a transposed all-ones matrix, and wherein the second invertible matrix comprises an identity matrix.

6. The processing system of claim 1, wherein the first invertible matrix comprises a Hadamard matrix, wherein the bias matrix comprises a zero matrix, and wherein the second invertible matrix comprises an identity matrix.

7. The processing system of claim 6, wherein the diffusion model is implemented by a diffusion transformer and wherein the layer is part of an attention block of the diffusion transformer.

8. The processing system of claim 1, wherein the input activation matrix is a zero-centered component matrix and wherein the one or more processors are configured to execute the processor-executable instructions and further cause the processing system to:
keep track of a residual mean removed from an initial activation matrix to generate the zero-centered component matrix; and
add the residual mean to the output of the layer.

9. The processing system of claim 1, wherein the one or more processors are configured to execute the processor-executable instructions and further cause the processing system to fuse a time modulation for the diffusion model into an initial weight matrix, together with an inverse rotation matrix, to generate the weight matrix, such that the weight matrix varies with time steps in the diffusion model.

10. The processing system of claim 1, wherein the bias matrix has a sequence length dimension and a feature dimension.

11. The processing system of claim 1, wherein to apply the affine transform, the one or more processors are configured to execute the processor-executable instructions and cause the processing system to determine a mean and a scale of the input activation matrix, wherein the first invertible matrix is based on the scale, and wherein the bias matrix is based on the mean.

12. The processing system of claim 11, wherein the mean is a dynamic mean and wherein the scale is a dynamic scale.

13. A mobile device comprising the processing system of claim 1.

14. A processor-implemented method for machine learning, comprising:
applying an affine transform to an input activation matrix for a layer of a diffusion model to generate a transformed input activation matrix, the affine transform comprising a bias matrix, a first invertible matrix having a sequence length dimension, and a second invertible matrix having a feature dimension;
quantizing the transformed input activation matrix to generate a quantized transformed input activation matrix;
quantizing a fused weight matrix to generate a quantized fused weight matrix, the fused weight matrix being a first matrix product of a weight matrix and an inverse of the second invertible matrix;
matrix multiplying the quantized transformed input activation matrix with the quantized fused weight matrix to generate a second matrix product;
matrix multiplying an inverse of the first invertible matrix with the second matrix product to generate a third matrix product;
matrix multiplying the bias matrix with the weight matrix to generate a fourth matrix product;
outputting a sum of the third matrix product and the fourth matrix product as an output of the layer of the diffusion model; and
generating, with the diffusion model, an output of the diffusion model, based at least in part on the output of the layer.

15. The processor-implemented method of claim 14, wherein the first invertible matrix is not an identity matrix.

16. The processor-implemented method of claim 14, wherein the first invertible matrix comprises an inverse of a diagonal matrix with a scaling value, wherein the bias matrix comprises a vector multiplied by a transposed all-ones matrix, and wherein the second invertible matrix comprises a Hadamard matrix rescaled by a diagonal matrix with a constant factor.

17. The processor-implemented method of claim 16, wherein the scaling value is based in part on a standard deviation of a column of the input activation matrix and wherein the vector is a mean vector representing an average over a sequence dimension of the input activation matrix.

18. The processor-implemented method of claim 14, wherein the first invertible matrix comprises an inverse of a diagonal matrix with a scaling value, wherein the bias matrix comprises a vector multiplied by a transposed all-ones matrix, and wherein the second invertible matrix comprises an identity matrix.

19. The processor-implemented method of claim 14, wherein the first invertible matrix comprises a Hadamard matrix, wherein the bias matrix comprises a zero matrix, and wherein the second invertible matrix comprises an identity matrix.

20. The processor-implemented method of claim 19, wherein the diffusion model is implemented by a diffusion transformer and wherein the layer is part of an attention block of the diffusion transformer.

21. The processor-implemented method of claim 14, wherein the input activation matrix is a zero-centered component matrix, the method further comprising:
keeping track of a residual mean removed from an initial activation matrix to generate the zero-centered component matrix; and
adding the residual mean to the output of the layer.

22. The processor-implemented method of claim 14, further comprising fusing a time modulation for the diffusion model into an initial weight matrix, together with an inverse rotation matrix, to generate the weight matrix, such that the weight matrix varies with time steps in the diffusion model.

23. The processor-implemented method of claim 14, wherein the bias matrix has a sequence length dimension and a feature dimension.

24. The processor-implemented method of claim 14, wherein applying the affine transform comprises determining a mean and a scale of the input activation matrix, wherein the first invertible matrix is based on the scale and wherein the bias matrix is based on the mean.

25. The processor-implemented method of claim 24, wherein the mean is a dynamic mean and wherein the scale is a dynamic scale.

26. A processing system comprising:
means for applying an affine transform to an input activation matrix for a layer of a diffusion model to generate a transformed input activation matrix, the affine transform comprising a bias matrix, a first invertible matrix having a sequence length dimension, and a second invertible matrix having a feature dimension;
means for quantizing the transformed input activation matrix to generate a quantized transformed input activation matrix;
means for quantizing a fused weight matrix to generate a quantized fused weight matrix, the fused weight matrix being a first matrix product of a weight matrix and an inverse of the second invertible matrix;
means for matrix multiplying the quantized transformed input activation matrix with the quantized fused weight matrix to generate a second matrix product;
means for matrix multiplying an inverse of the first invertible matrix with the second matrix product to generate a third matrix product;
means for matrix multiplying the bias matrix with the weight matrix to generate a fourth matrix product;
means for outputting a sum of the third matrix product and the fourth matrix product as an output of the layer of the diffusion model; and
means for generating an output of the diffusion model based at least in part on the output of the layer.
